(19) United States
(12) Patent Application Publication
(10) Pub. No.: US 2015/0189100 A1
(43) Pub. Date: Jul. 2, 2015

(54) Multi-level Missed Call Notification Priority Assignment

(71) Applicant: FUTUREWEI TECHNOLOGIES, INC., Plano, TX (US)

(72) Inventor: April Wang, San Diego, CA (US)

(73) Assignee: FUTUREWEI TECHNOLOGIES, INC., Plano, TX (US)

(21) Appl. No.: 14/141,023

(22) Filed: Dec. 26, 2013

(51) Int. Cl. H04M 19/04; H04M 3/42

(52) U.S. Cl. CPC H04M 19/041; H04M 3/42195; H04M 3/42059; H04M 19/047; H04M 19/048

(57) ABSTRACT

Notifications used to notify called parties of missed calls can vary based on priority levels of the missed calls. Priority levels can be assigned using characteristics of the missed call, such as a calling number/party associated with the missed call, a number of missed calls received from the calling number/party, whether or not the calling party left a voicemail, a time the missed call was received, or combinations thereof. Different notification levels may be associated with different priority levels, with each notification level specifying different alert setting parameters, e.g., different sounds/volumes, visual notifications, vibration settings, etc. Some notification levels may override a silent mode of the mobile device, while other notifications levels may not. Priority levels can be escalated when users fail to acknowledge a notification prior to expiration of a timer or when notification attempts are unsuccessful.

### TECHNICAL FIELD

The present invention relates generally to telecommunications, and, in particular embodiments, to methods for multi-level missed call notification priority assignment.

### BACKGROUND

The recent proliferation of wireless telecommunications has led many subscribers to become more and more reliant on their mobile devices. For some users, it is important to remain reliably accessible via their mobile phones so that family, business contacts, and clients can reach them at a moment's notice. Nevertheless, users may be unable to access their mobile phone in some circumstances, and may consequently miss a call relating to an important issue, such as a family emergency or a professional obligation requiring the user's immediate attention. As such, techniques and mechanisms for alerting users of important missed calls when they are away from their mobile devices are desired.

### SUMMARY OF THE INVENTION

Technical advantages are generally achieved, by embodiments of this disclosure which describe techniques for multi-level missed call notification priority assignment.

In accordance with an embodiment, a method for missed call notification is provided. In this example, the method includes detecting a missed call on a mobile device of a called party, assigning a priority level to the missed call in accordance with one or more characteristics of the missed call, and notifying the called party of the missed call in accordance with a first notification level associated with the assigned priority level. Different notification levels are associated with different priority levels. An apparatus and computer program product for performing this method are also provided.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of a wireless network for communicating data;

FIG. 2 illustrates a diagram of a missed call in a wireless network;

FIG. 3 illustrates a flowchart of an embodiment method for performing missed call notification;

FIG. 4 illustrates a flowchart of another embodiment method for performing missed call notification;

FIG. 5 illustrates a flowchart of an embodiment method for selecting a missed call priority assignment agent;

FIG. 6 illustrates a diagram of an embodiment missed call notification system;

FIG. 7 illustrates a diagram of another embodiment missed call notification system;

FIG. 8 illustrates a flowchart of an embodiment method for assigning priority levels to missed calls;

FIG. 9 illustrates a flowchart of an embodiment method for operating an alert signal generator;

FIG. 10 illustrates a flowchart of an embodiment method for operating auto-dialer;

FIG. 11 illustrates a flowchart of an embodiment method for operating a message generator;

FIG. 12 illustrates a diagram of a user interface for configuring parameters of a missed call notification application on a mobile device; and

FIG. 13 illustrates a block diagram of an embodiment communications device.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims. The term mobile device should be interpreted to include the mobile device as well as applications installed on the mobile device. Accordingly, actions described as being performed by a mobile device should be interpreted to include functions performed by applications installed on the mobile device unless otherwise specified.

Aspects of this disclosure provide techniques for alerting users of missed calls based on priority levels assigned to the missed calls. More specifically, a priority level is assigned to a missed call based on one or more characteristics of the missed call. Characteristics of a missed call can include a calling number/party associated with a missed call, a number of missed calls received from the calling number/party, whether or not the calling party left a voicemail, a time the missed call was received, or other parameters associated with the missed call. Different notification levels may be associated with different priority levels, with each notification level specifying different alert setting parameters to be used to notify the user of a corresponding missed call. By way of example, a first notification level may alert the user by emitting a sound, while a second notification level may alert the user by emitting a sound and a flash. As another example, different notification levels may alert the user by emitting different sounds or by emitting the same sound at different volumes. Additionally, missed call alerts may behave differently when the mobile device is operating in a silent mode. For example, some notification levels may override a silent mode of the mobile device, while other notifications levels may not. Additionally, a priority level may be escalated when users fail to acknowledge a notification prior to expiration of a timer. These and other aspects are described in greater detail below.

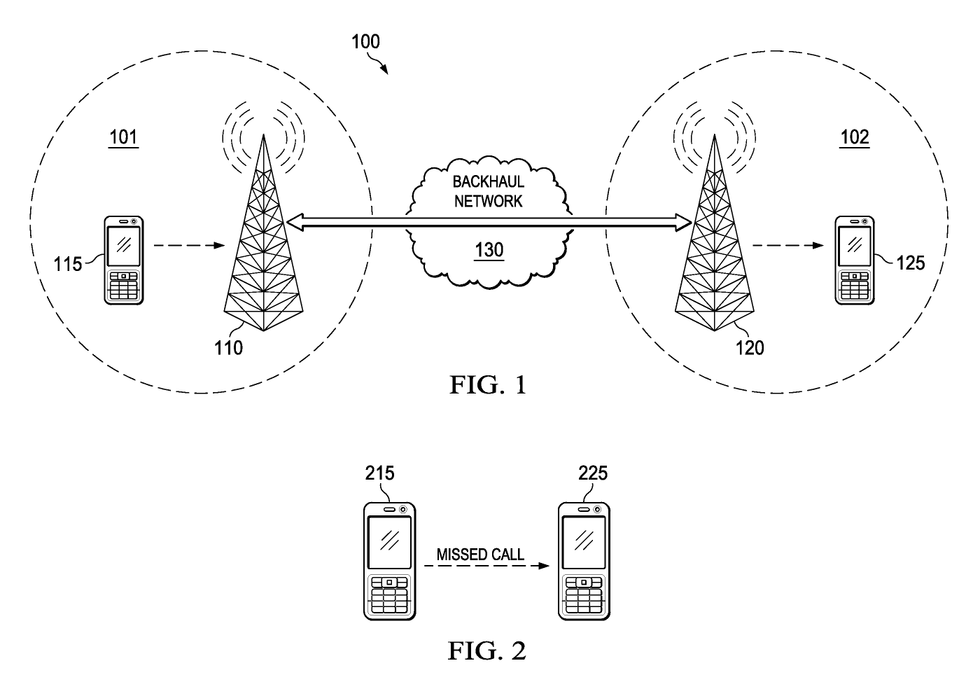

FIG. 1 illustrates a network 100 comprising an access point (AP) 110 having a coverage area 101, an AP 120 having a coverage area 102, and a backhaul network 130 for allowing the AP 110 to communicate with the AP 120, and vice versa. In this example, a called mobile device 125 receives a missed call from a calling mobile device 115. This missed call scenario is simplified in FIG. 2, which shows a mobile device 225 of a called party receiving a missed call from a mobile device 215 of a called party. Notably, while the called party is depicted as using mobile devices 115, 215, embodiments of this disclosure are equally applicable to calls originating from a landline or non-wireless calling platform, e.g., Skype, etc. A calling party may be any device, entity, or person from which a call originates. A called party may be any entity or person to which a call is placed (e.g., an intended recipient of a call). A mobile device of a called party may be any wireless device associated with (e.g., used by, registered to, etc.) the called party.

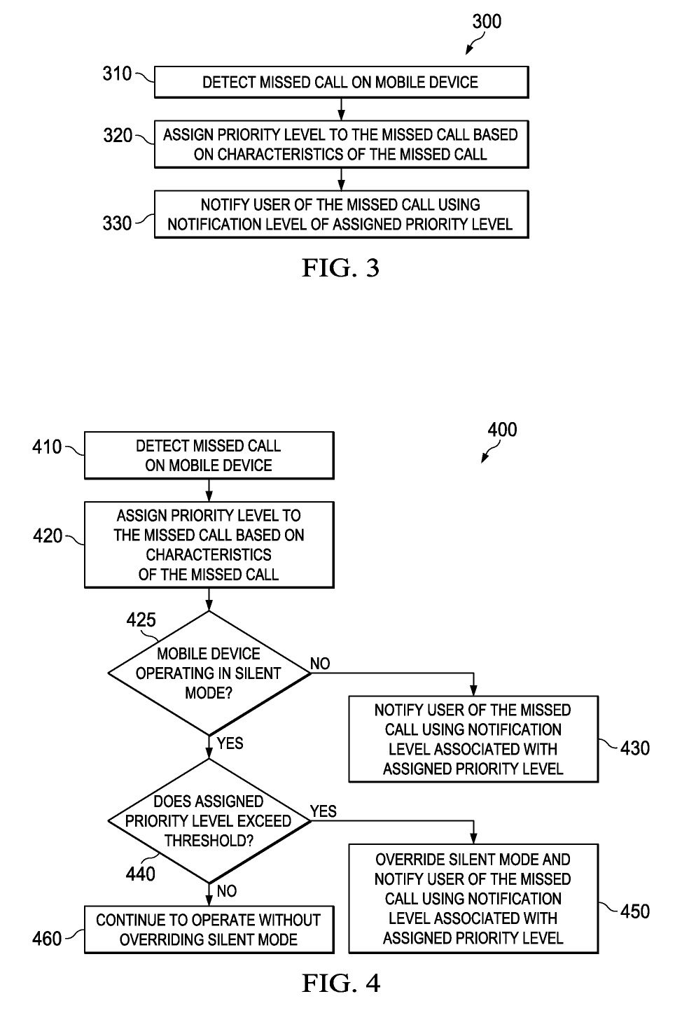

Embodiment missed call notification techniques may use different alert settings to notify users of missed calls having different priority levels. FIG. 3 illustrates an embodiment method 300 for missed call notification. As shown, the method 300 begins at step 310, where a missed call is detected on the mobile device. A missed call may be detected when a call is not answered by the user. Next, the method 300 proceeds to step 320, where a priority level is assigned to the missed call based on a characteristic of the missed call. The characteristic can include any parameter associated with the missed call, such as calling number/party associated with a missed call, a number of missed calls received from the calling number/party, whether or not a voicemail was left by the calling party, etc. In one embodiment, a higher priority level is assigned when a calling number/party associated with the missed call is included in a list of privileged calling numbers. In another embodiment, a higher priority level is assigned when a number of missed calls received from a calling number/party (consecutive or otherwise) exceeds a threshold. In yet another embodiment, a higher priority level is assigned when a calling party leaves a voicemail. After assigning the priority level to the missed call, the method 300 proceeds to step 330, where the mobile device notifies the user of the missed call using a notification level associated with the assigned priority level.

Missed call notification techniques may adapt to situations where a mobile device is operating in a silent mode. FIG. 4 illustrates another embodiment method 400 for missed call notification. As shown, the method 400 begins at step 410, where a missed call is detected on the mobile device. Next, the method 400 proceeds to step 420, where the mobile device assigns a priority level to the missed call based on a characteristic of the missed call. Subsequently, the method 400 proceeds to step 425, where it is determined whether or not the mobile device is operating in a silent mode. If not, the method 400 proceeds to step 430, where the mobile device notifies the user of the missed call using a notification level associated with the assigned priority level.

If the mobile device is operating in a silent mode, then the method 400 proceeds to step 440, where the mobile device determines whether the assigned priority level exceeds a threshold for overriding the silent mode. If so, the method 400 proceeds to step 450, where the mobile device overrides the silent mode and notifies the user of the missed call using a notification level associated with the assigned priority level. If the assigned priority level is not high enough to override the silent mode, then the method 400 proceeds to step 460, where the mobile device continues to operate without overriding the silent mode.

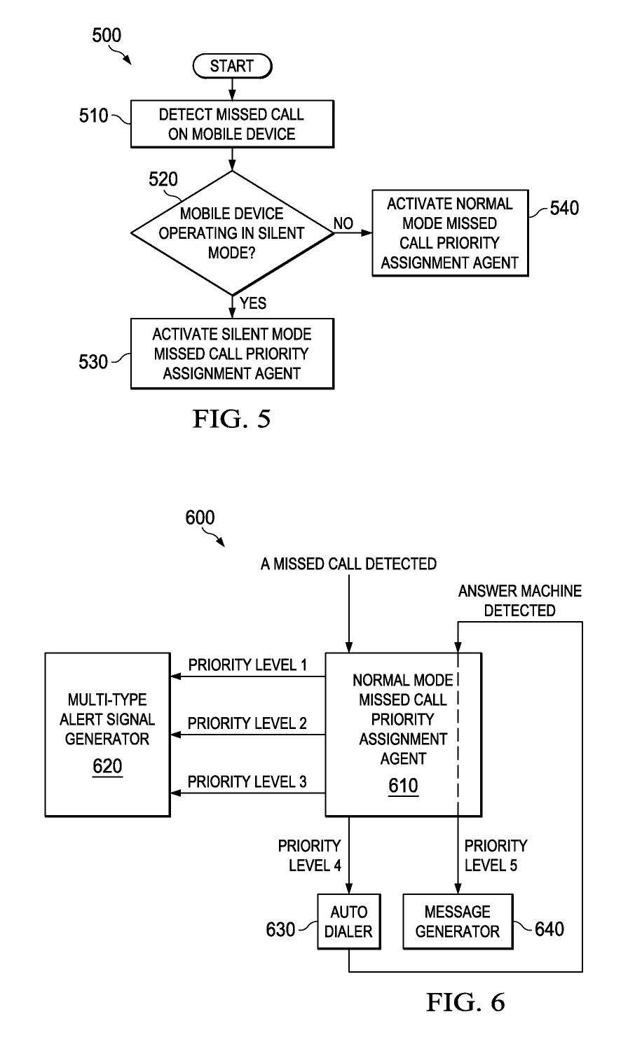

In some embodiments, different missed call notification agents are used depending on whether the mobile device is operating in a silent or normal operating mode. FIG. 5 illustrates an embodiment method 500 for determining which priority assignment agent to activate in the event of a missed call. As shown, the method 500 begins with step 510, where a missed call is detected on a mobile device. Subsequently, the method 500 proceeds to step 520, where it is determined whether or not the mobile device is operating in a silent mode. If so, the method proceeds to step 530, where the silent mode missed call priority assignment agent is activated. Alternatively, if the mobile device is not operating in a silent mode, then the method proceeds to step 540, where the normal mode missed call priority assignment agent is activated.

Normal mode missed call priority assignment agents may differ from silent mode missed call priority assignment agents. FIG. 6 illustrates a system 600 comprising a normal mode missed call priority assignment agent 610 configured to alert a user of a missed call. As shown, the normal mode missed call priority assignment agent 610 triggers one of a multiple type alert signal generator 620, an auto dialer 630, and a message generator 640 depending on the priority level assigned to the missed call. In this example, five priority levels are used. However, embodiments of this disclosure may utilize any number of priority levels. As shown, the normal mode missed call priority assignment agent 610 triggers the multi-type alert signal generator 620 when a missed call is assigned priority level one, two, or three. The multi-type alert signal generator 620 may use different alerts and/or alert settings depending on the assigned priority level. For example, the multi-type alert signal generator 620 may use different tones, sounds, or volumes for priority levels one, two, and three. As another example, the multi-type alert signal generator 620 may use different combinations of sound, vibration, and flash for priority levels one, two, and three.

The normal mode missed call priority assignment agent 610 triggers the auto-dialer 630 when the missed call is escalated to priority level four upon the user's failing to acknowledge a notification associated with priority level three prior to expiration of a timer. In some embodiments, the auto-dialer 630 is configured to notify the called party by dialing contact numbers associated with the called party. For example, the auto-dialer 630 may call the home or office number of the called party depending on, for instance, the time of day in which the missed call is received. In the same or other embodiments, the auto-dialer 630 is configured to dial contact numbers associated with contacts of the called party. For example, the auto-dialer 630 may call a spouse or colleague of the called party. The contact numbers may be called sequentially in accordance with a predefined order, which may be configured by the called party. For example, the spouse's mobile phone may be called after calling the called party's work and/or home phone. In some embodiments, different predefined orders may be associated with different time periods. For example, the called party's assistant may be dialed first when the missed call is received during working hours, while the called party's spouse may be dialed first when the missed call is received outside normal working hours. The user may configure any parameter associated with missed call notification, such as the calling list(s), calling sequence(s), time period(s), notification level(s), etc. In some embodiments, contacts may be asked for permission to be added to a given contact list.

In some embodiments, the priority level of a missed call may be escalated from priority level four to priority level five when the auto dialer 630 is unsuccessful in reaching a called contact number. The auto dialer 630 may determine that a called contact is unreachable in a variety of situations, such as when an answering machine is detected, when a timer elapses, when a number of rings exceeds a threshold, when a call is prematurely ended (e.g., called contact answers and quickly hangs up), or when an automated voice indicates that the call cannot be completed as dialed. In other embodiments, the priority level five may be assigned directly (e.g., without first assigning priority level four) based on a characteristic of the missed call.

When a missed call is assigned priority level five, the normal mode missed call priority assignment agent 610 triggers the message generator 640. The message generator 640 may generate any type of message, including automated voice messages, text messages (e.g., Short Message Service (SMS) messages, etc.), email messages, and others. The message generator 640 may send the generated message to a single contact or to a group of contacts. In some embodiments, the set of contact numbers and/or email addresses may be associated with the called party. In other embodiments, the set of contact numbers and/or email addresses may be associated with contacts of the called party, e.g., friends, family, colleagues, etc.

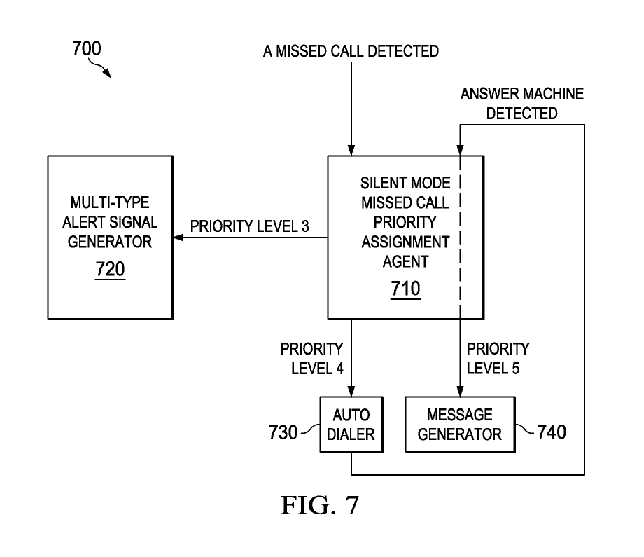

Silent mode missed call priority assignment agents may be activated when a missed call is detected during a silent mode operation of the mobile device. Silent mode missed call priority assignment agents may suppress notification alerts for low priority missed calls while overriding the silent mode for high priority missed calls. FIG. 7 illustrates a system 700 comprising a silent mode missed call priority assignment agent 710 configured to alert a user of a missed call by triggering a multiple type alert signal generator 720, an auto dialer 730, and/or a message generator 730 depending on the assigned priority level. In this example, the silent mode missed call priority assignment agent 710 suppress notifications for missed calls assigned priority levels one or two, and overrides the silent mode of the mobile device for missed calls that are assigned priority level three, four, or five.

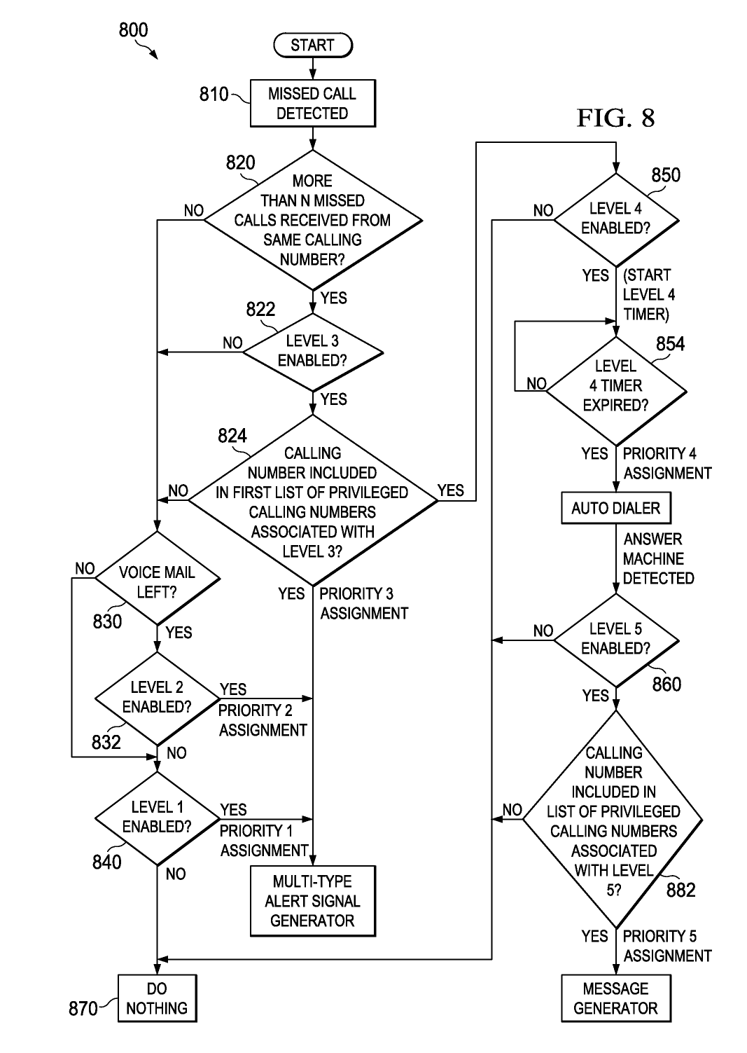

Aspects of this disclosure provide techniques for assigning a priority level to a missed call when a mobile device is operating in a normal mode. FIG. 8 illustrates a flow chart of an embodiment method 800 for processing missed calls while a mobile device is operating in a normal mode, as might be performed by the mobile device. The method 800 begins at step 810, when a missed call is detected on a mobile device. Thereafter, the method 800 proceeds to step 820, where the mobile device determines whether a number of missed calls from a calling number of the most recently detected missed call exceeds a threshold. If so, then the method 800 proceeds to step 822, wherein the mobile device determines whether priority level three is activated. If priority level three is activated, then the method 800 proceeds to step 824, where the mobile device determines whether the calling number of the missed call is included in a list of privileged calling numbers associated with priority level three. In some embodiments, priority levels can be activated/de-activated by the user using a user interface, e.g., a menu on the mobile device. If so, the missed call is assigned priority level three, the multi-type alert signal generator is triggered, and the method 800 proceeds to step 850 (which is discussed in greater detail below).

If either priority level three is disabled or the calling number is excluded from the list of privileged calling numbers associated with priority level three, then the method 800 proceeds to step 830, where the mobile device determines whether a voicemail was left. If so, the method 800 proceeds to step 832, where the mobile device determines whether priority level two is enabled. If priority level two is enabled, then the missed call is assigned priority level two and the multi-type alert signal generator is triggered.

If either priority level two is disabled or the calling party did not leave a voicemail, then the method 800 proceeds to step 840, where the mobile device determines whether priority level one is enabled. If priority level one is enabled, then the missed call is assigned priority level one and the multi-type alert signal generator is triggered. If priority level one is disabled, then the method 800 proceeds to step 870, where no further action is taken in regards to the missed call.

Referring back to step 824, if the calling number of the missed call is included in the list of privileged calling numbers associated with priority level three, then the method 800 proceeds to step 850, where the mobile device determines whether or not priority level four is enabled. If so, the method 800 starts a level four timer and proceeds to step 854, where the method determines whether the called party acknowledges the missed call alert from the multi-type alert signal generator prior to expiration of the level four timer. If the level four timer expires prior to the user acknowledging the missed call notification, then the method 800 activates the auto dialer, which dials a contact number in an attempt to notify the called party of the missed call. The contact number may be registered to the called party, or a contact of the called party (e.g., another user that is different from the called party). If the auto dialer determines that the called contact is unavailable, then the method 800 proceeds to step 860, where the mobile device determines whether priority level five is enabled. If so, the method 800 proceeds to step 882, where the mobile device determines whether the calling number is included in a list of privileged calling numbers associated with priority level five. If the calling number is included in a list of privileged calling numbers associated with priority level five, then the message generator is triggered.

If it is determined that priority level four is disabled in step 850, that the user acknowledged the missed call notification prior to expiration of the level four timer in step 854, that priority level five is disabled in step 860, or that the calling number is excluded from the list of calling numbers associated with priority level five in step 882, then the method 800 proceeds to step 870, where no further steps are taken to notify the user of the missed call.

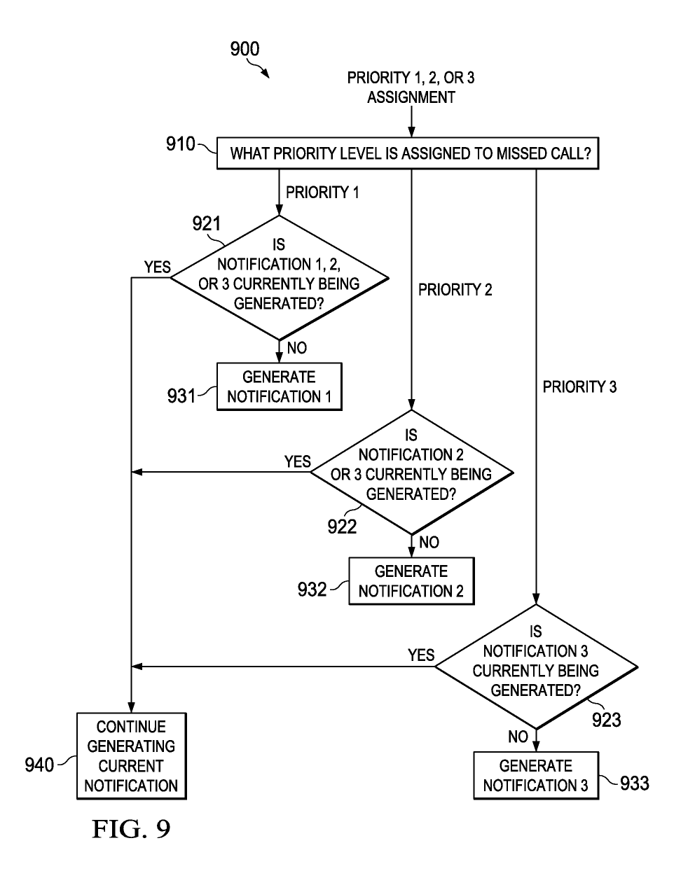

Aspects of this disclosure provide techniques for operating a multiple type alert signal generator to alert a called party of a missed call. FIG. 9 illustrates a flow chart of an embodiment method 900 for operating an alert signal generator, as might be performed by a mobile device. As shown, the method 900 begins at step 910, where the mobile device determines which priority level is assigned to the missed call.

If priority level one is assigned to the missed call, then the method 900 proceeds to step 921, where the mobile device determines whether any of notification one, notification two, or notification three are presently being generated. If not, then the method 900 proceeds to step 931, where the mobile device generates notification one. Otherwise, if notification one, notification two, or notification three is already being generated, then the method 900 proceeds to step 940, where the mobile device continues to generate the current notification, e.g., if notification two was being generated prior to most recent call, then mobile device continues to generate notification level two.

If priority level two is assigned to the missed call, then the method 900 proceeds to step 922, where the mobile device determines whether notification two or notification three is presently being generated. If not, then the method 900 proceeds to step 932, where the mobile device generates notification two. Otherwise, if notification two or notification three is already being generated, then the method 900 proceeds to step 940, where the mobile device continues to generate the current notification.

If priority level three is assigned to the missed call, then the method 900 proceeds to step 923, where the mobile device determines whether notification three is already being generated. If not, then the method 900 proceeds to step 933, where the mobile device generates notification three. Otherwise, if notification three is already being generated, then the method 900 proceeds to step 940, where the mobile device continues to generate notification three.

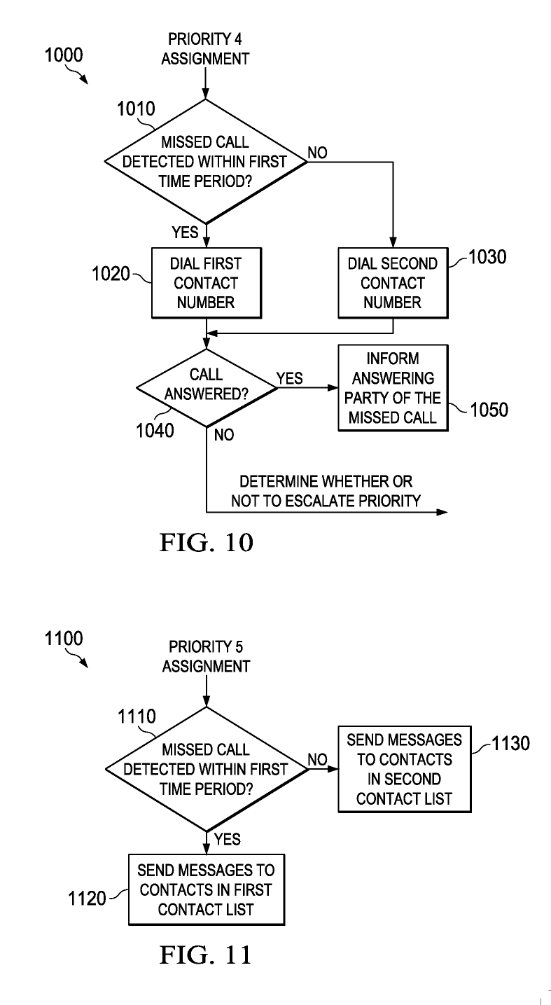

Aspects of this disclosure provide techniques for operating an auto-dialer to alert a called party of a missed call. FIG. 10 illustrates a flow chart of an embodiment method 1000 for operating an auto-dialer. As shown, the method 1000 begins with step 1010, where the mobile device determines whether the missed call was detected during a first time period. In some examples, the first time period may correspond to daylight hours. In other examples, the first time period may correspond to another user defined time period, e.g., normal working hours, nighttime hours, weekend or holiday hours, etc. If the missed call was detected within the first time period, then the method 1000 proceeds to step 1020, where the mobile device dials a first contact number. In some embodiments, the mobile device may sequentially dial contact numbers in a first list of contact numbers when performing step 1020. If the missed call was detected outside of the first time period, then the method 1000 proceeds to step 1030, where the mobile device dials a second contact number. In some embodiments, the mobile device may sequentially dial contact numbers in a second list of contact numbers when performing step 1030. The contact numbers and/or sequences of calling numbers dialed in steps 1020, 1030 may be pre-configured by the called party. In some embodiments, the dialed contact number may be an alternate number of the called party, e.g., an office or home phone number of the called party. In other embodiments, the dialed contact number may be associated with a contact of the called party, e.g., friend, spouse, co-worker, etc.

Thereafter, the method 1000 proceeds to step 1040, where the mobile device determines whether the call is answered. If so, the method 1000 proceeds to step 1050, where the mobile device informs the answering party of the missed call and/or asks the answering party to notify the called party of the missed call. If the call goes unanswered, then the method 1000 may end, and the mobile device may determine whether or not to escalate the missed call to the next level of priority.

Aspects of this disclosure provide techniques for operating a message generator to alert a called party of a missed call. FIG. 11 illustrates a flow chart of an embodiment method 1100 for operating a message generator. As shown, the method 1100 begins with step 1110, where the mobile device determines whether the missed call was detected during a first time period. If the missed call was detected within the first time period, then the method 1100 proceeds to step 1120, where the mobile device sends messages to contacts in a first list of contacts. Otherwise, if the missed call was detected outside the first period, then the method 1100 proceeds to step 1130, where the mobile device sends messages to contacts in a second list of contacts. The messages sent to contacts in the first or second list of contacts may request that the recipient notify the called party of the missed call. In some examples, the messages specify a name and calling number of a calling party from which the missed call was received. In other examples, the messages may afford some degree of privacy to the called party and/or the calling party. For instance, the messages may specify a name of the calling party without specifying a calling number of the calling party. Alternatively, the messages may specify a calling number of the calling party without specifying the name of the calling party. As yet another alternative, the messages may specify a time of the missed call and whether or not a voicemail was left by the calling party without specifying any contact information (e.g., calling number, name, etc.) associated with the calling party. As yet another alternative, the message may specify a class associated with the calling party (e.g., client, colleague, immediate/extended family member, etc.) without specifying contact information of the calling party. Other alternatives may specify different information, or different combinations of information, pertaining to the missed call and/or calling party.

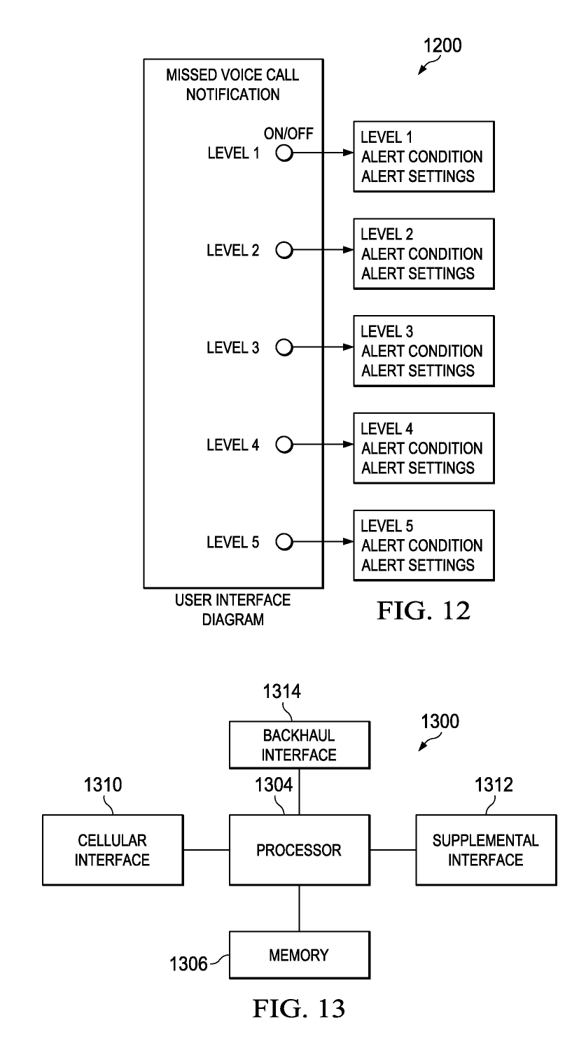

The missed call notification techniques of this disclosure may be fully configurable by a user of the mobile device. FIG. 12 illustrates an embodiment user interface 1200 for setting up and/or managing parameters of a missed call notification application. As shown, the user can enable/disable each notification level, as well as configure alert settings and alert conditions for each notification level. Alert conditions may include any condition or event that triggers assignment/use of a corresponding priority and/or notification level. For example, alert conditions can specify that a particular priority level is assigned when a calling party leaves a voice mail. As another example, alert conditions can specify that a particular priority level is assigned when a specified number of missed calls are received from the same calling number. As yet another example, alert conditions can specify that a particular priority level is assigned when the calling number is included in a list of privileged calling numbers associate with the priority level. Alert conditions can also specify conditions for escalating the priority level of a missed call. For instance, alert conditions can specify that the priority level assigned to a missed call is escalated after expiration of a timer or when a dialed call goes unanswered. Alert settings may specify the type and manner in which a called party is notified of the missed call. For instance, alert settings may specify which alerts (e.g., sound, flash, vibration, etc.) and/or alert parameters (e.g., tone, volume, flash sequence, vibration sequence, period, etc.) are used by the multiple type alert generator. Alert settings may specify which alert generator (e.g., the multiple type alert generator, the auto-dialer, the message generator) is used for a particular notification level. Alert settings may also specify which contacts or contacts lists are used by the auto-dialer and/or message generator, as well as the conditions in which they are used. For instance, the alert settings may specify a nighttime contact list and a daytime contact list, as well as the respective time periods for which each contact list is associated.

FIG. 13 illustrates a block diagram of an embodiment of a communications device 1300, which may be equivalent to one or more devices (e.g., UEs, NBs, etc.) discussed above. The communications device 1300 may include a processor 1304, a memory 1306, a cellular interface 1310, a supplemental interface 1312, and a backhaul interface 1314, which may (or may not) be arranged as shown in FIG. 13. The processor 1304 may be any component capable of performing computations and/or other processing related tasks, and the memory 1306 may be any component capable of storing programming, user data and/or instructions for the processor 1304. The cellular interface 1310 may be any component or collection of components that allows the communications device 1300 to communicate using a cellular signal, and may be used to receive and/or transmit information over a cellular connection of a cellular network. The supplemental interface 1312 may be any component or collection of components that allows the communications device 1300 to communicate data or control information via a supplemental protocol. For instance, the supplemental interface 1312 may be a non-cellular wireless interface for communicating in accordance with a Wireless-Fidelity (Wi-Fi) or Bluetooth protocol. Alternatively, the supplemental interface 1312 may be a wireline interface. The backhaul interface 1314 may be optionally included in the communications device 1300, and may comprise any component or collection of components that allows the communications device 1300 to communicate with another device via a backhaul network.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A method for missed call notification, the method comprising:
detecting a missed call on a mobile device, the mobile device being associated with a called party;
assigning a first one of a plurality of priority levels to the missed call in accordance with one or more characteristics of the missed call; and
notifying, by the mobile device, the called party of the missed call in accordance with a first notification level associated with the first priority level, wherein different notification levels are associated with different priority levels.

2. The method of claim 1, wherein assigning the first priority level to the missed call in accordance with the one or more characteristics of the missed call comprises:
assigning a higher priority level to the missed call when a voicemail is left by the calling party.

3. The method of claim 1, wherein assigning the first priority level to the missed call in accordance with the one or more characteristics of the missed call comprises:
determining a number of missed calls associated with a calling number of the missed call; and
assigning a higher priority level to the missed call when the number of missed calls exceed a threshold.

4. The method of claim 1, wherein assigning the first priority level to the missed call in accordance with the one or more characteristics of the missed call comprises:
determining whether a calling number of the missed call is included in a list of privileged calling numbers; and
assigning a higher priority level to the missed call when the calling number of the missed call is included in the list of privileged calling numbers.

5. The method of claim 1, further comprising:
escalating the assigned priority level of the missed call from the first priority level to a second priority level when a notification is not acknowledged prior to expiration of a timer, the second priority level being associated with a second notification level that is different than the first notification level.

6. The method of claim 1, further comprising:
escalating the assigned priority level of the missed call from the first priority level to a second priority level when a notification attempt is unsuccessful.

7. The method of claim 1, wherein the plurality of priority levels include a second priority level, and wherein the second priority level is associated with a second notification level that is different than the first notification level.

8. The method of claim 7, wherein notifying the called party in accordance with the first notification level comprises:
prompting the mobile device to emit a sound specified by the first notification level, wherein a different sound is specified by the second notification level.

9. The method of claim 7, wherein notifying the called party in accordance with the first notification level comprises:
prompting the mobile device to emit a sound at a volume specified by the first notification level 1, wherein a different volume is specified by the second notification level.

10. The method of claim 9, wherein the second notification level specifies that the volume is muted.

11. The method of claim 7, wherein notifying the called party in accordance with the first notification level comprises:
prompting the mobile device to vibrate in accordance with vibration settings specified by the first notification level, wherein different vibration settings are specified by the second notification level.

12. The method of claim 11, wherein the second notification level specifies that vibration settings are muted.

13. The method of claim 7, wherein notifying the called party in accordance with the second notification level comprises:
prompting the mobile device to emit a visual notification specified by the first notification level, wherein a different visual notification is specified by the second notification level.

14. The method of claim 7, wherein notifying the called party in accordance with the first notification level comprises:
prompting the mobile device to emit a visual notification specified by the first notification level, wherein no visual notification is specified by the second notification level.

15. The method of claim 1, wherein notifying the called party in accordance with the first notification level comprises:
determining that the mobile device is operating in a silent mode;
overriding the silent mode of the mobile device when the first priority level exceeds a threshold level; and
prompting the mobile device to emit a sound to notify the called party of the missed call when the silent mode is overridden.

16. The method of claim 1, wherein notifying the called party in accordance with the notification level of the first priority level comprises:
determining that the first notification level is associated with a vibration and a sound;
determining that the mobile device is operating in a silent mode;
prompting the mobile device to vibrate without emitting the sound when the first priority level is below a threshold; and
prompting the mobile device to vibrate and to emit the sound when the first priority level exceeds the threshold.

17. The method of claim 1, wherein notifying the called party in accordance with the notification level of the first priority level comprises:
determining that the first notification level is associated with a visual notification and a sound;
determining that the mobile device is operating in a silent mode;
prompting the mobile device to emit the visual notification without emitting the sound when the first priority level is below a threshold; and
prompting the mobile device to emit both the visual notification and the sound when the first priority level exceeds the threshold.

18. The method of claim 1, wherein prompting the mobile device to notify the called party of the missed call in accordance with the first notification level comprises:
prompting the mobile device to continue notifying the called party in accordance with the first notification level until the notification is acknowledged or a timer expires; and
escalating the assigned priority level of the missed call from the first priority level to a second priority level when the notification is not acknowledged prior to expiration of the timer, the second priority level being associated with a second notification level that is different than the first notification level; and
prompting the mobile device to notify the called party in accordance with the second notification level after the timer expires.

19. The method of claim 18, wherein prompting the mobile device to notify the called party in accordance with the second notification level after the timer expires comprises:
prompting the mobile device to call an alternative contact number of the called party.

20. The method of claim 19, wherein prompting the mobile device to notify the called party in accordance with the second notification level after the timer expires comprises:
determining whether the missed call is received during a first time period;
prompting the mobile device to call a first contact number of the called party when the missed call was received during the first time period; and
prompting the mobile device to call a second contact number of the called party when the missed call is received outside the first time period, the second contact number being different than the first contact number.

21. The method of claim 19, wherein escalating the notification level of the mobile device further comprises:
prompting the mobile device to send a text message to one or more contact numbers upon determining that the call to the alternative contact number went unanswered.

22. The method of claim 21, wherein the one or more contact numbers include at least one contact number that is not registered to the called party.

23. The method of claim 21, wherein the one or more contact numbers include at least one contact number that is registered to the called party.

24. An apparatus comprising:
a processor; and
a non-transitory computer readable storage medium storing programming for execution by the processor, the programming including instructions to:
detect a missed call on a mobile device, the mobile device being associated with a called party;
assign a first one of a plurality of priority levels to the missed call in accordance with one or more characteristics of the missed call; and
notify the called party of the missed call in accordance with a first notification level associated with the first priority level, wherein different notification levels are associated with different priority levels.

25. The apparatus of claim 24, wherein the plurality of priority levels include a second priority level, and wherein the second priority level is associated with a second notification level that is different than the first notification level.

26. The apparatus of claim 25, wherein the instructions to notify the called party in accordance with the first notification level include instructions to:
prompt the mobile device to emit a sound specified by the first notification level, wherein a different sound is specified by the second notification level.

27. The apparatus of claim 25, wherein the instructions to notify the called party in accordance with the first notification level include instructions to:
prompt the mobile device to emit a sound at a volume specified by the first notification level, wherein a different volume is specified by the second notification level.

28. A computer program product for installation on a mobile device, the computer program product comprising programming for execution by the mobile device, the programming including instructions to:
detect a missed call on a mobile device, the mobile device being associated with a called party;
assign a first one of a plurality of priority levels to the missed call in accordance with one or more characteristics of the missed call; and
notify the called party of the missed call in accordance with a first notification level associated with the first priority level, wherein different notification levels are associated with different priority levels.

29. The computer program product of claim 28, wherein the plurality of priority levels include a second priority level, and wherein the second priority level is associated with a second notification level that is different than the first notification level.

30. The computer program product of claim 29, wherein the instructions to notify the called party in accordance with the first notification level include instructions to:
prompt the mobile device to emit a sound specified by the first notification level, wherein a different sound is specified by the second notification level.

31. The computer program product of claim 29, wherein the instructions to notify the called party in accordance with the first notification level include instructions to:
prompt the mobile device to emit a sound at a volume specified by the first notification level, wherein a different volume is specified by the second notification level.
